(19) United States
(12) Patent Application Publication
(10) Pub. No.: US 2025/0167245 A1
(43) Pub. Date: May 22, 2025

(54) LITHIUM SECONDARY BATTERY AND METHOD OF PRODUCING LITHIUM SECONDARY BATTERY

(71) Applicant: TOYOTA JIDOSHA KABUSHIKI KAISHA, Toyota-shi (JP)

(72) Inventors: Ryo ASAKURA, Sunto-gun (JP); Shinya SHIOTANI, Nagoya-shi (JP); Sakina KANEKO, Fujisawa-shi (JP)

(73) Assignee: TOYOTA JIDOSHA KABUSHIKI KAISHA, Toyota-shi (JP)

(21) Appl. No.: 18/887,479

(22) Filed: Sep. 17, 2024

(30) Foreign Application Priority Data
Nov. 17, 2023 (JP) 2023-196217

(51) Int. Cl. H01M 4/62; H01M 4/02; H01M 4/04; H01M 4/36; H01M 4/38; H01M 4/46; H01M 10/052

(52) U.S. Cl. CPC H01M 4/628; H01M 4/0445; H01M 4/366; H01M 4/387; H01M 4/466; H01M 10/052; H01M 2004/021; H01M 2004/027

(57) ABSTRACT

An object of the present disclosure is to provide a lithium secondary battery in which the cycle characteristics can be improved while increasing the reversible capacity. A lithium secondary battery comprising a negative electrode current collector layer, a first lithium-tin alloy layer, a lithium-magnesium alloy layer, an electrolyte layer, a positive electrode active material layer; and a positive electrode current collector layer, in the order mentioned.

### FIELD

The present disclosure relates to a lithium secondary battery, and a method of producing a lithium secondary battery.

### BACKGROUND

In lithium secondary batteries, a lithium metal and/or a lithium alloy, which have a high ionization tendency among metals, are used as negative electrode active materials. Such lithium secondary batteries are expected to be put into practical use since they not only have a large potential difference between a negative electrode and a positive electrode and thus provide a high output voltage, but also have a high theoretical capacity density, and the following batteries have been disclosed.

For example, PTL 1 discloses an all solid-state battery in which a precipitation-dissolution reaction of metallic lithium is utilized as a negative electrode reaction, and which includes: a positive electrode including a positive electrode layer; a negative electrode including a negative electrode current collector and a negative electrode layer; and a solid electrolyte layer arranged between the positive electrode layer and the negative electrode layer. This all solid-state battery is characterized in that: the negative electrode layer contains a 8 single-phase alloy of metallic lithium and metallic magnesium as a negative electrode active material; and, when the all solid-state battery is fully charged, a ratio of lithium element in the alloy is 81.80 atomic % to 99.97 atomic %. According to PTL1, an all solid-state battery having a high charge-discharge efficiency can be provided.

PTL 2 discloses an all solid-state secondary battery which includes: a positive electrode layer including a positive electrode active material layer; a negative electrode layer; and a solid electrolyte layer that is arranged between the positive electrode layer and the negative electrode layer and contains a solid electrolyte. In this all solid-state secondary battery, the negative electrode layer includes a negative electrode current collector, a first negative electrode active material layer in contact with the solid electrolyte layer, and a second negative electrode active material layer arranged between the negative electrode current collector and the first negative electrode active material layer; the first negative electrode active material layer contains a first carbonaceous negative electrode active material; the second negative electrode active material layer contains a second carbonaceous negative electrode active material; and an intensity ratio (I¹_{D}/I¹_{G}) of a D-band peak and a G-band peak in a Raman spectrum of the first carbonaceous negative electrode active material is lower than an intensity ratio (I²_{D}/I²_{G}) of the same of the second carbonaceous negative electrode active material. According to PTL 2, an all solid-state secondary battery having excellent cycle characteristics, in which short-circuiting is inhibited, can be provided.

### CITATION LIST

### Patent Literature

[PTL 1] Japanese Unexamined Patent Publication (Kokai) No. 2020-184513
[PTL 2] Japanese Unexamined Patent Publication (Kokai) No. 2021-132033

### SUMMARY

### Technical Problem

Lithium secondary batteries are expected to have excellent battery characteristics; however, actually, lithium secondary batteries have a low reversible capacity and are still insufficient in terms of cycle characteristics. Therefore, lithium secondary battery have room for improvement from the standpoint of reversible capacity and cycle characteristics.

In view of the above, an object of the present disclosure is to provide a lithium secondary battery in which the cycle characteristics can be improved while increasing the reversible capacity.

### Solution to Problem

The present disclosure achieves the above-described object by the following means.

### <Aspect 1>

A lithium secondary battery comprising a negative electrode current collector layer, a first lithium-tin alloy layer, a lithium-magnesium alloy layer, an electrolyte layer, a positive electrode active material layer; and a positive electrode current collector layer, in the order mentioned.

### <Aspect 2>

The lithium secondary battery according to Aspect 1, wherein, in a fully-charged state, the first lithium-tin alloy layer has a thickness of 0.1 to 15 μm.

### <Aspect 3>

The lithium secondary battery according to Aspect 1 or 2, wherein, in a fully-charged state, the lithium-magnesium alloy layer has a thickness of 0.1 to 40 μm.

### <Aspect 4>

The lithium secondary battery according to any one of Aspects 1 to 3, comprising the negative electrode current collector layer, the first lithium-tin alloy layer, the lithium-magnesium alloy layer, a second lithium-tin alloy layer, the electrolyte layer, the positive electrode active material layer, and the positive electrode current collector layer, in the order mentioned.

### <Aspect 5>

The lithium secondary battery according to any one of Aspects 1 to 4, wherein, in a fully-charged state, the first lithium-tin alloy layer has a thickness of 0.1 to 15 μm, and the second lithium-tin alloy layer has a thickness of 0.1 to 15 μm.

### <Aspect 6>

A method of producing the lithium secondary battery according to any one of Aspects 1 to 5, the method comprising the following steps of:
obtaining a preliminary lithium secondary battery by laminating the negative electrode current collector layer, a tin-containing first metal layer, a magnesium-containing second metal layer, the electrolyte layer, the positive electrode active material layer retaining lithium, and the positive electrode current collector layer, in the order mentioned; and
performing a charging operation of the preliminary lithium secondary battery to: (i) allow tin of the first metal layer to react with lithium migrating from the positive electrode active material layer, and thereby form the lithium-tin alloy layer; and (ii) allow magnesium of the second metal layer to react with lithium migrating from the positive electrode active material layer, and thereby form the lithium-magnesium alloy layer.

### <Aspect 7>

A method of producing the lithium secondary battery according to any one of Aspects 1 to 5, the method including the following steps of:
obtaining the preliminary lithium secondary battery by laminating the negative electrode current collector layer, a tin-containing first metal layer, a magnesium-containing second metal layer, a tin-containing third metal layer, the electrolyte layer, the positive electrode active material layer retaining lithium, and the positive electrode current collector layer, in the order mentioned; and
performing a charging operation of the preliminary lithium secondary battery to: (i) allow tin of the first metal layer to react with lithium migrating from the positive electrode active material layer, and thereby form the first lithium-tin alloy layer; (ii) allow magnesium of the second metal layer to react with lithium migrating from the positive electrode active material layer, and thereby form the lithium-magnesium alloy layer; and (iii) allow tin of the third metal layer to react with lithium migrating from the positive electrode active material layer, and thereby forming the second lithium-tin alloy layer.

### Advantageous Effects of Invention

According to the lithium secondary battery of the present disclosure, the cycle characteristics can be improved while increasing the reversible capacity.

### BRIEF DESCRIPTION OF DRAWINGS

FIG. 1 is a schematic drawing for illustrating the lithium secondary battery of the present disclosure.

FIG. 2 is a schematic drawing for illustrating another aspect of the lithium secondary battery of the present disclosure.

FIG. 3 is a schematic drawing for illustrating a method of producing the lithium secondary battery of the present disclosure.

FIG. 4 is a schematic drawing for illustrating another aspect of a method of producing the lithium secondary battery of the present disclosure.

FIGS. 5A through 5F provide images showing the results of EDX mapping analysis by cross-sectional SEM-EDX for each element with regard to a lithium secondary battery E2 of Example 2 (FIG. 5A: an overlay of sulfur(S), oxygen (O), tin (Sn), magnesium (Mg), and nickel (Ni) elements; FIG. 5B: S; FIG. 5C: O; FIG. 5D: Sn; FIG. 5E: Mg; and FIG. 5F: Ni).

FIGS. 6A through 6B provide cross-sectional SEM images of the lithium secondary battery E2 of Example 2 (FIG. 6A is a cross-sectional SEM image, and FIG. 6B is a schematic drawing of a cross-sectional structure).

### DESCRIPTION OF EMBODIMENTS

Embodiments of the present disclosure will now be described in detail. The present disclosure is, however, not limited to the below-described embodiments, and can be carried out with various modifications within the scope of the gist of the present disclosure. In the descriptions of the drawings, the same symbol is assigned to the same element, and redundant descriptions are omitted.

Regarding the present disclosure, the term “mixture” means a composition which, by itself or by further containing other components, can constitute a positive electrode active material layer or an electrolyte layer. Further, regarding the present disclosure, the term “mixture slurry” means a slurry which contains a dispersion medium in addition to a “mixture”, and can thus be applied and dried to form a positive electrode active material layer or an electrolyte layer.

The lithium secondary battery of the present disclosure may be a liquid battery containing an electrolyte solution as an electrolyte layer, or may be a solid-state battery including a solid electrolyte layer as an electrolyte layer. Regarding the present disclosure, the term “solid-state battery” means a battery in which at least a solid electrolyte is used as an electrolyte and, accordingly, a solid-state battery may contain, as an electrolyte, a combination of a solid electrolyte and a liquid electrolyte. Further, the lithium secondary battery of the present disclosure may be an all-solid-state battery, i.e. a battery in which only a solid electrolyte is used as an electrolyte.

### <<Lithium Secondary Battery>>

The lithium secondary battery of the present disclosure comprises a negative electrode current collector layer, a first lithium-tin alloy layer, a lithium-magnesium alloy layer, an electrolyte layer, a positive electrode active material layer, and a positive electrode current collector layer, in the order mentioned.

According to the lithium secondary battery of the present disclosure, the cycle characteristics can be improved while increasing the reversible capacity.

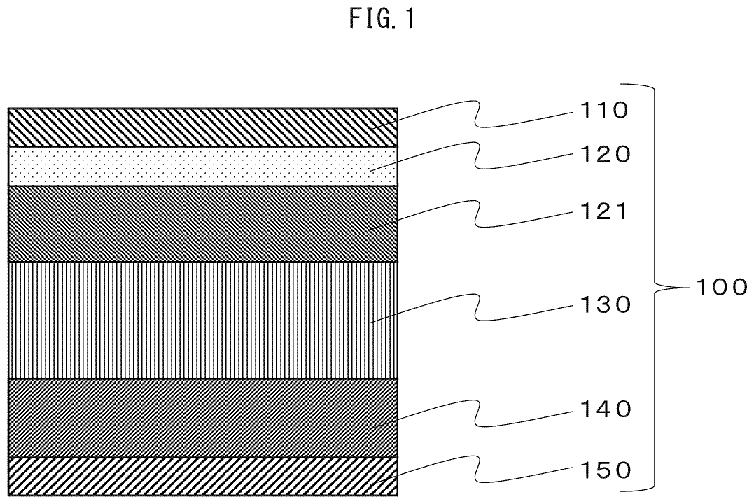

As illustrated in FIG. 1, specifically, the lithium secondary battery of the present disclosure comprises a first lithium-tin alloy layer 120 between a negative electrode current collector layer 110 and a lithium-magnesium alloy layer 121. It is presumed that, by the first lithium-tin alloy layer 120, the interfacial delamination between the negative electrode current collector layer 110 and the lithium-magnesium alloy layer 121 is inhibited during discharging, as a result of which the cycle characteristics can be improved while increasing the reversible capacity.

The following is considered as a factor that allows the first lithium-tin alloy layer 120 to inhibit the interfacial delamination between the negative electrode current collector layer 110 and the lithium-magnesium alloy layer 121, although the details thereof are not clear. During discharging, from the standpoint of reaction potential, dealloying of lithium contained in the lithium-magnesium alloy layer 121 proceeds preferentially to dealloying of lithium contained in the first lithium-tin alloy layer 120; therefore, the lithium-magnesium alloy layer 121 contracts greatly. On the other hand, a dealloying reaction of the first lithium-tin alloy layer 120 is less likely to proceed than that of the lithium-magnesium alloy layer 121, and the first lithium-tin alloy layer 120 thus contracts less than the lithium-magnesium alloy layer 121; therefore, the contraction of the lithium-magnesium alloy layer 121 is relaxed by the first lithium-tin alloy layer 120, and it is presumed that the above-described interfacial delamination can be inhibited as a result.

### <Negative Electrode Current Collector Layer>

A material used in the negative electrode current collector layer is not particularly limited, and any material that is generally used as a negative electrode current collector of a lithium secondary battery can be adopted as appropriate. Examples of the material used in the negative electrode current collector layer include, but are not limited to, Cu, Ni, Cr, Au, Pt, Ag, Al, Fe, Ti, Zn, Co, stainless steel, and carbon sheets. Particularly, from the standpoint of ensuring a reduction resistance and the standpoint of making alloy formation with lithium difficult, the material used in the negative electrode current collector layer may contain at least one metal selected from Cu, Ni, and stainless steel, or may consist of a carbon sheet. The negative electrode current collector layer may have a coating layer of some kind on its surface for the purpose of, for example, adjusting the resistance.

A shape of the negative electrode current collector layer is not particularly limited, and examples thereof include a foil shape, a plate shape, and a mesh shape. Thereamong, a foil shape is preferred.

A thickness of the negative electrode current collector layer is not particularly limited, and may be 0.1 μm or more, or 1 μm or more, but 1 mm or less, or 100 μm or less.

### <First Lithium-Tin Alloy Layer>

The first lithium-tin alloy layer contains a lithium element and a tin element and, as desired, may further contain other metal elements that form an alloy with lithium. It is believed that, depending on the charge/discharge state, the first and the second lithium-tin alloy layers also function as negative electrode active material layers in the lithium secondary battery of the present disclosure.

A thickness of the first lithium-tin alloy layer is not particularly limited, and may be 0.1 to 15 μm in a fully-charged state. The thickness of the first lithium-tin alloy layer may be, but not particularly limited to, 0.1 μm or more, 0.2 μm or more, 0.4 μm or more, 0.6 μm or more, 0.8 μm or more, or 1.0 μm or more, but 15 μm or less, 10 μm or less, 5 μm or less, or 3 μm or less.

With regard to a method of forming the first lithium-tin alloy layer, reference can be made to the below-described “<<Method of Producing Lithium Secondary Battery>>”.

### <Lithium-Magnesium Alloy Layer>

The lithium-magnesium alloy layer contains a lithium element and a magnesium element and, as desired, may further contain other metal elements that form an alloy with lithium. In the lithium secondary battery of the present disclosure, this lithium-magnesium alloy layer functions as a negative electrode active material layer.

A thickness of the lithium-magnesium alloy layer is not particularly limited, and may be 0.1 to 40 μm in a fully-charged state. The thickness of the lithium-magnesium alloy layer may be, but not particularly limited to, 0.1 μm or more, 0.2 μm or more, 0.4 μm or more, 0.6 μm or more, 0.8 μm or more, or 1.0 μm or more, but 40 μm or less, 35 μm or less, 30 μm or less, 25 μm or less, or 20 μm or less.

With regard to a method of forming the lithium-magnesium alloy layer, reference can be made to the below-described “<<Method of Producing Lithium Secondary

### Battery>>”.

### <Electrolyte Layer>

### <Electrolyte Layer-Solid Electrolyte Layer>

The lithium secondary battery of the present disclosure may be a solid-state battery, i.e. may include a solid electrolyte layer as an electrolyte layer.

The solid electrolyte layer, if necessary, may contain a binder and the like in addition to a solid electrolyte.

### (Solid Electrolyte)

A material of the solid electrolyte is not particularly limited and may be, for example, a sulfide solid electrolyte, an oxide solid electrolyte, or a polymer electrolyte.

Examples of the sulfide solid electrolyte include, but are not limited to, sulfide-based amorphous solid electrolytes, sulfide-based crystalline solid electrolytes, and argyrodite-type solid electrolytes. Specific examples of the sulfide solid electrolyte include, but are not limited to: Li₂S—P₂S₅-based electrolytes (e.g., Li₇P₃S₁₁, Li₃PS₄, and Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (e.g., Li₁₃GeP₃S₁₆ and Li₁₀GeP₂S₁₂), LiI—Li₂S—P₂O₅, LiI—Li₃PO₄—P₂S₅, and Li₇₋ₓPS₆₋ₓClₓ; and combinations thereof.

Examples of the oxide solid electrolyte include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, and Li₃₊ₓPO₄₋ₓNₓ (LiPON).

The sulfide solid electrolyte and the oxide solid electrolyte may each be a glass or a crystallized glass (glass-ceramic).

Examples of the polymer electrolyte include, but are not limited to, polyethylene oxide (PEO), polypropylene oxide (PPO), and copolymers thereof.

### (Binder)

The binder is not particularly limited. The binder may be, for example, but not limited to, a polyvinylidene fluoride (PVdF), a butadiene rubber (BR), a polytetrafluoroethylene (PTFE), or a styrene-butadiene rubber (SBR). The binder is not particularly limited, and may be used singly, or in combination of two or more kinds thereof.

A thickness of the solid electrolyte layer is not particularly limited and may be, for example, 0.1 μm or more, 1 μm or more, or 10 μm or more, but 2 mm or less, 1 mm or less, or 500 μm or less.

The solid electrolyte layer can be easily formed by, for example, dry-molding or wet-molding an electrolyte mixture containing the above-described solid electrolyte, binder, and the like.

### <Electrolyte Layer-Separator Layer>

The lithium secondary battery of the present disclosure may be a liquid battery, i.e. may include an electrolyte solution, particularly an electrolyte solution retained in a separator layer, as an electrolyte layer.

### (Electrolyte Solution)

The electrolyte solution is not particularly limited, and preferably contains a supporting salt and a solvent.

The supporting salt (lithium salt) of the electrolyte solution having a lithium ion conductivity is not particularly limited and may be, for example, an inorganic lithium salt or an organic lithium salt. Examples of the inorganic lithium salt include, but are not limited to, LiPF₆, LiBF₄, LiCIO₄, and LiAsF₆. Examples of the organic lithium salt include, but are not limited to, LiCF₃SO₃, LiN(CF₃SO₂)₂, LIN (C₂F₅SO₂)₂, LiN(FSO₂)₂, and LiC(CF₃SO₂)₃.

The solvent used in the electrolyte solution is not particularly limited and may be, for example, a cyclic carbonate or a chain carbonate. Examples of the cyclic carbonate include, but are not limited to, ethylene carbonate (EC), propylene carbonate (PC), and butylene carbonate (BC). Examples of the chain carbonate include, but are not limited to, dimethyl carbonate (DMC), diethyl carbonate (DEC), and ethyl methyl carbonate (EMC). The electrolyte solution is not particularly limited, and may be used singly, or in combination of two or more kinds thereof.

### (Separator)

The separator is not particularly limited, and any separator that is generally used as a separator of a lithium secondary battery can be adopted as appropriate. As the separator, for example, a polyolefin-based, polyamide-based, or polyimide-based nonwoven fabric can be used.

### <Positive Electrode Active Material Layer>

The positive electrode active material layer contains at least a positive electrode active material and, as desired, may further contain a conductive auxiliary agent, a solid electrolyte, a binder, and the like. In addition, the positive electrode active material layer may contain other various additives. In the positive electrode active material layer, the content of each of the positive electrode active material, the conductive auxiliary agent, the binder, and the like may be determined as appropriate in accordance with the target battery performance. For example, taking the whole amount (all solids) of the positive electrode active material layer as 100% by mass, the content of the positive electrode active material may be 40% by mass or more, 50% by mass or more, or 60% by mass or more, but 100% by mass or less, or 90% by mass or less.

### (Positive Electrode Active Material)

The positive electrode active material is not particularly limited as long as it is capable of occluding and releasing lithium ions. The positive electrode active material may be, for example, but not limited to, lithium cobaltate (LiCoO₂), lithium nickelate (LiNiO₂), lithium manganate (LiMn₂O₄), nickel cobalt lithium manganate (NCM), LiCO_{1/3}Ni_{1/3}Mn_{1/3}O₂, nickel cobalt lithium aluminate (NCA; LiNiₓCo_{y}Al_{z}O₂), or a heteroelement-substituted Li—Mn spinel having a composition represented by Li₁₊ₓMn_{2-x-y}M_{y}O₄ (wherein, M represents at least one metal element selected from the group consisting of Al, Mg, Co, Fe, Ni, and Zn).

The positive electrode active material is not particularly limited, and may have a coating layer. The coating layer is a layer containing a substance which exhibits a lithium ion conductivity, has a low reactivity with the positive electrode active material or the solid electrolyte, and can maintain a form of a coating layer that is not fluidized even when coming into contact with the active material or the solid electrolyte. Specific examples of a material constituting the coating layer include, but are not limited to, LiNbO₃, Li₄Ti₅O₁₂, and Li₃PO₄.

A shape of the positive electrode active material is not particularly limited as long as it is a shape that is common for positive electrode active materials of lithium secondary batteries. For example, the positive electrode active material may be in the form of particles. The positive electrode active material may be primary particles, or secondary particles formed by aggregation of plural primary particles. The positive electrode active material may have an average particle size D₅₀ of, for example, 1 nm or more, 5 nm or more, or 10 nm or more, but 500 μm or less, 100 μm or less, 50 μm or less, or 30 μm or less. The average particle size D₅₀ is a particle size (median diameter) at a cumulative value of 50% in a volume-based particle size distribution determined by a laser diffraction-scattering method.

### (Conductive Auxiliary Agent)

The conductive auxiliary agent is not particularly limited. Examples of the conductive auxiliary agent include, but are not limited to, vapor-grown carbon fibers (VGCFs), acetylene black (AB), Ketjen black (KB), carbon nanotubes (CNTs), and carbon nanofibers (CNFs). The conductive auxiliary agent may be in the form of, for example, particles or fibers, and a size thereof is not particularly limited. The conductive auxiliary agent is not particularly limited, and may be used singly, or in combination of two or more kinds thereof.

With regard to the solid electrolyte and the binder, reference can be made to the above-described “<Electrolyte Layer-Solid Electrolyte Layer>”.

A shape of the positive electrode active material layer is not particularly limited, and the positive electrode active material layer may be in the form of, for example, a sheet having a substantially flat surface. A thickness of the positive electrode active material layer is also not particularly limited and may be, for example, 0.1 μm or more, 1 μm or more, or 10 μm or more, but 2 mm or less, 1 mm or less, or 500 μm or less.

### <Positive Electrode Current Collector Layer>

A material used in the positive electrode current collector layer is not particularly limited, and any material that is generally used as a positive electrode current collector of a lithium secondary battery can be adopted as appropriate. Examples of the material used in the positive electrode current collector layer include, but are not limited to, Cu, Ni, Cr, Au, Pt, Ag, Al, Fe, Ti, Zn, Co, and stainless steel. The positive electrode current collector layer may have a coating layer of some kind on its surface for the purpose of, for example, adjusting the resistance. Further, the positive electrode current collector layer may be a metal foil or a substrate on which any of the above-described metals is plated or vapor-deposited.

A shape of the positive electrode current collector layer is not particularly limited, and examples thereof include a foil shape, a plate shape, and a mesh shape. Thereamong, a foil shape is preferred.

A thickness of the positive electrode current collector layer is not particularly limited, and may be 0.1 μm or more, or 1 μm or more, but 1 mm or less, or 100 μm or less.

The positive electrode active material layer can be produced by applying any known method. The positive electrode active material layer can be easily molded by, for example, dry-molding or wet-molding a positive electrode mixture containing the above-described various components. The positive electrode active material layer may be molded together with the positive electrode current collector layer, or may be molded separately from the positive electrode current collector layer.

Examples of the shape of the lithium secondary battery include, but are not limited to, a coin shape, a laminated shape (pouch battery), a cylindrical shape, and a prismatic shape.

FIG. 1 is a schematic drawing that illustrates one aspect of the lithium secondary battery of the present disclosure; however, the lithium secondary battery of the present disclosure is not limited to this case.

A lithium secondary battery 100 is a battery in which a negative electrode current collector layer 110, a first lithium-tin alloy layer 120, a lithium-magnesium alloy layer 121, an electrolyte layer 130, a positive electrode active material layer 140, and a positive electrode current collector layer 150 are laminated in the order mentioned. By the first lithium-tin alloy layer 120 arranged between the negative electrode current collector layer 110 and the lithium-magnesium alloy layer 121, the interfacial delamination between the negative electrode current collector layer 110 and the lithium-magnesium alloy layer 121 is inhibited during discharging, as a result of which the cycle characteristics can be improved while increasing the reversible capacity.

### <Another Aspect of Lithium Secondary Battery>

The lithium secondary battery of the present disclosure may comprise a negative electrode current collector layer, a first lithium-tin alloy layer, a lithium-magnesium alloy layer, a second lithium-tin alloy layer, an electrolyte layer, a positive electrode active material layer, and a positive electrode current collector layer in the order mentioned.

### <Second Lithium-Tin Alloy Layer>

The second lithium-tin alloy layer contains a lithium element and a tin element and, as desired, may further contain other metal elements that form an alloy with lithium.

A thickness of the second lithium-tin alloy layer is not particularly limited, and may be 0.1 to 15 μm in a fully-charged state. A thickness of the second lithium-tin alloy layer is not particularly limited, and may be 0.1 μm or more, 0.2 μm or more, 0.4 μm or more, 0.6 μm or more, 0.8 μm or more, or 1.0 μm or more, but 15 μm or less, 10 μm or less, 5 μm or less, or 3 μm or less.

With regard to a method of forming the second lithium-tin alloy layer, reference can be made to the below-described “<<Method of Producing Lithium Secondary Battery>>”.

With regard to the negative electrode current collector, the first lithium-tin alloy layer, the lithium-magnesium alloy layer, the electrolyte layer, the positive electrode active material layer, and the positive electrode current collector layer, reference can be made to the above description of “<<Lithium Secondary Battery>>”.

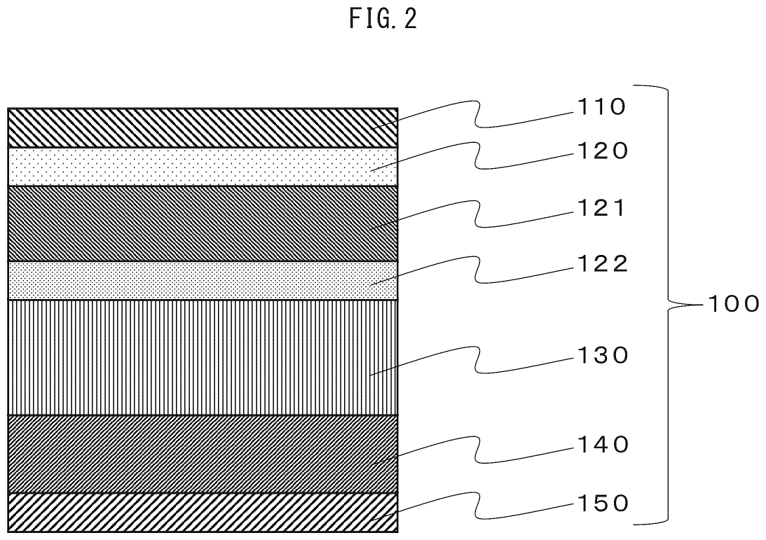

FIG. 2 is a schematic drawing that illustrates another aspect of the lithium secondary battery of the present disclosure; however, the lithium secondary battery of the present disclosure is not limited to this case.

The lithium secondary battery 100 is a battery in which the negative electrode current collector layer 110, the first lithium-tin alloy layer 120, the lithium-magnesium alloy layer 121, a second lithium-tin alloy layer 122, the electrolyte layer 130, the positive electrode active material layer 140, and the positive electrode current collector layer 150 are laminated in the order mentioned. By the first lithium-tin alloy layer 120 arranged between the negative electrode current collector layer 110 and the lithium-magnesium alloy layer 121, the interfacial delamination between the negative electrode current collector layer 110 and the lithium-magnesium alloy layer 121 is inhibited during discharging, as a result of which the cycle characteristics can be improved while increasing the reversible capacity. In addition, by the second lithium-tin alloy layer 122 arranged between the lithium-magnesium alloy layer 121 and the electrolyte layer 130, the interfacial delamination between the lithium-magnesium alloy layer 121 and the electrolyte layer 130 is inhibited during discharging, as a result of which the cycle characteristics can be further improved.

### <<Method of Producing Lithium Secondary Battery>>

The lithium secondary battery of the present disclosure can be produced by a method including the following steps of:
obtaining a preliminary lithium secondary battery by laminating a negative electrode current collector layer, a tin-containing first metal layer, a magnesium-containing second metal layer, an electrolyte layer, a positive electrode active material layer retaining lithium, and a positive electrode current collector layer, in the order mentioned; and
performing a charging operation of the preliminary lithium secondary battery to: (i) allow tin of the first metal layer to react with lithium migrating from the positive electrode active material layer, and thereby form the lithium-tin alloy layer; and (ii) allow magnesium of the second metal layer to react with lithium migrating from the positive electrode active material layer, and thereby forming the lithium-magnesium alloy layer.

According to the method of producing the lithium secondary battery of the present disclosure, a lithium secondary battery in which the cycle characteristics can be improved while increasing the reversible capacity can be produced.

### <First Metal Layer>

The first metal layer contains a tin element and, as desired, may further contain other metal elements that form an alloy with lithium.

A thickness of the first metal layer is not particularly limited, and may be 0.01 μm or more, 0.02 μm or more, 0.05 μm or more, 0.10 μm or more, but 0.50 μm or less, 0.40 μm or less, 0.30 μm or less, or 0.2 μm or less.

Specifically, the first metal layer can be formed by, for example, but is not limited to, forming a tin layer on the negative electrode current collector by a sputtering method.

### <Second Metal Layer>

The second metal layer contains a magnesium element and, as desired, may further contain other metal elements that form an alloy with lithium.

A thickness of the second metal layer is not particularly limited, and may be 0.02 μm or more, 0.05 μm or more, 0.10 μm or more, 0.20 μm or more, but 3.0 μm or less, 2.0 μm or less, 1.0 μm or less, or 0.50 μm or less.

Specifically, the second metal layer can be formed by, for example, but is not limited to, forming a magnesium layer on the first metal layer by a sputtering method.

With regard to the negative electrode current collector, the electrolyte layer, the positive electrode active material layer, and the positive electrode current collector layer, reference can be made to the above description of “<<Lithium Secondary Battery>>”.

### <Preliminary Lithium Secondary Battery>

The preliminary lithium secondary battery is a laminate in which the negative electrode current collector layer, the tin-containing first metal layer, the magnesium-containing second metal layer, the electrolyte layer, the positive electrode active material layer retaining lithium, and the positive electrode current collector layer are laminated in the order mentioned.

Specifically, the preliminary lithium secondary battery can be easily formed by, for example, laminating the negative electrode current collector, the first metal layer, the second metal layer, the electrolyte layer, the positive electrode active material layer, and the positive electrode current collector layer in the order mentioned, housing the resulting laminate in a laminated film, and then vacuum-sealing and pressing the resultant.

### (Charging Operation)

The charging operation can be performed, for example, under a constant current-constant voltage condition in a cut-off voltage range of 4.2 V to 3.0 V. By the charging operation, lithium is released from the positive electrode active material retaining lithium that is contained in the positive electrode active material layer, and the thus released lithium migrates to the first metal layer and the second metal layer.

A current amount (C rate) in the charging operation is not particularly limited, and may be 0.01 C or more, 0.02 C or more, 0.03 C or more, or 0.05 C or more, but 0.20 C or less, 0.10 C or less, 0.075 C or less, or 0.05 C or less.

A temperature during the charging operation is not particularly limited. The temperature during the charging operation may be 0° C. or higher, 10° C. or higher, 20° C. or higher, 30° C. or higher, 40° C. or higher, 50° C. or higher, or 60° C. or higher, but 200° C. or lower, 150° C. or lower, 120° C. or lower, 100° C. or lower, or 80° C. or lower.

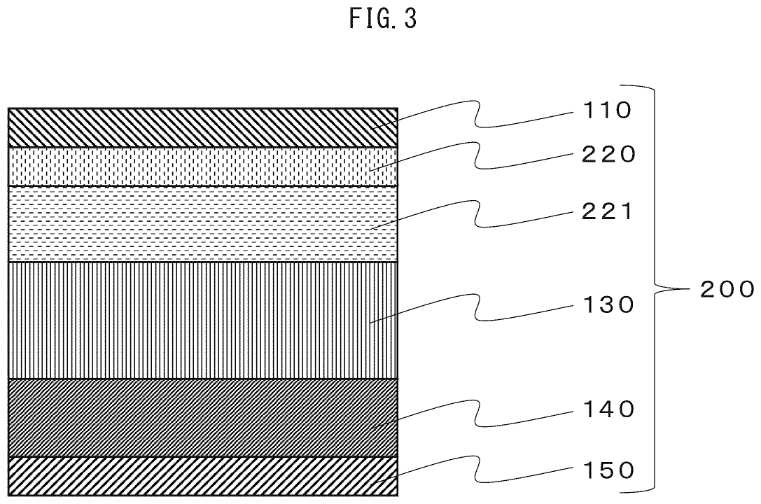

FIG. 3 is a schematic drawing that illustrates one aspect of the preliminary lithium secondary battery in the method of producing the lithium secondary battery of the present disclosure; however, the preliminary lithium secondary battery is not limited to this case. A specific method of producing the lithium secondary battery of FIG. 1 from the preliminary lithium secondary battery of FIG. 3 will now be described referring to FIGS. 1 and 3; however, the method is not limited to this case.

A preliminary lithium secondary battery 200 of FIG. 3 is a laminate in which the negative electrode current collector layer 110, a first metal layer 220, a second metal layer 221, the electrolyte layer 130, the positive electrode active material layer 140, and the positive electrode current collector layer 150 are laminated in the order mentioned. The lithium secondary battery 100 of FIG. 1 can be produced by performing a charging operation of the preliminary lithium secondary battery 200 of FIG. 3. In other words, by performing the charging operation of the preliminary lithium secondary battery 200, tin of the first metal layer 220 is allowed to react with lithium migrating from the positive electrode active material layer 140 so as to form the first lithium-tin alloy layer 120 of FIG. 1, and magnesium of the second metal layer 221 is allowed to react with lithium migrating from the positive electrode active material layer 140 so as to form the lithium-magnesium alloy layer 121 of FIG. 1, whereby the lithium secondary battery 100 can be produced.

### <Another Aspect of Method of Producing Lithium Secondary Battery>

The lithium secondary battery of the present disclosure may also be produced by a method including the following steps of:
obtaining a preliminary lithium secondary battery by laminating a negative electrode current collector layer, a tin-containing first metal layer, a magnesium-containing second metal layer, a tin-containing third metal layer, an electrolyte layer, a positive electrode active material layer retaining lithium, and a positive electrode current collector layer, in the order mentioned; and
performing a charging operation of the preliminary lithium secondary battery to: (i) allow tin of the first metal layer to react with lithium migrating from the positive electrode active material layer, and thereby form the first lithium-tin alloy layer; (ii) allow magnesium of the second metal layer to react with lithium migrating from the positive electrode active material layer, and thereby form the lithium-magnesium alloy layer; and (iii) allow tin of the third metal layer to react with lithium migrating from the positive electrode active material layer, and thereby form the second lithium-tin alloy layer.

### <Third Metal Layer>

The third metal layer contains a tin element and, as desired, may further contain other metal elements that form an alloy with lithium.

A thickness of the third metal layer is not particularly limited, and may be 0.01 μm or more, 0.02 μm or more, 0.05 μm or more, 0.10 μm or more, but 0.50 μm or less, 0.40 μm or less, 0.30 μm or less, or 0.2 μm or less.

Specifically, the third metal layer can be formed by, for example, but is not limited to, forming a tin layer on the electrolyte layer by a sputtering method.

With regard to the negative electrode current collector, the electrolyte layer, the positive electrode active material layer, and the positive electrode current collector layer, reference can be made to the above description of “<<Lithium Secondary Battery>>”. With regard to the first metal layer and the second metal layer, reference can be made to the above description of “<<Method of Producing Lithium Secondary Battery>>”

In the preliminary lithium secondary battery, the negative electrode current collector layer, the tin-containing first metal layer, the magnesium-containing second metal layer, the tin-containing third metal layer, the electrolyte layer, the positive electrode active material layer retaining lithium, and the positive electrode current collector layer may be laminated in the order mentioned.

Specifically, the preliminary lithium secondary battery can be easily formed by, for example, laminating the negative electrode current collector, the first metal layer, the second metal layer, the third metal layer, the electrolyte layer, the positive electrode active material layer, and the positive electrode current collector layer in the order mentioned, housing the resulting laminate in a laminated film, and then vacuum-sealing and pressing the resultant.

With regard to the charging operation, reference can be made to the above description of “(Charging Operation)”

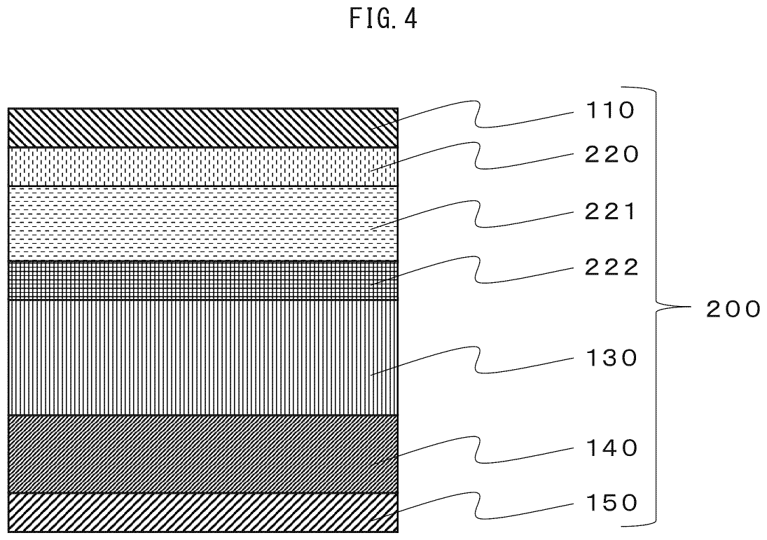

FIG. 4 is a schematic drawing that illustrates another aspect of the preliminary lithium secondary battery in the method of producing the lithium secondary battery of the present disclosure; however, the preliminary lithium secondary battery is not limited to this case. A specific method of producing the lithium secondary battery of FIG. 2 from the preliminary lithium secondary battery of FIG. 4 will now be described referring to FIGS. 2 and 4; however, the method is not limited to this case.

A preliminary lithium secondary battery 200 of FIG. 4 is a laminate in which the negative electrode current collector layer 110, the first metal layer 220, the second metal layer 221, the third metal layer 222, the electrolyte layer 130, the positive electrode active material layer 140, and the positive electrode current collector layer 150 are laminated in the order mentioned. The lithium secondary battery 100 of FIG. 2 can be produced by performing a charging operation of the preliminary lithium secondary battery 200 of FIG. 4. In other words, by performing the charging operation of the preliminary lithium secondary battery 200, tin of the first metal layer 220 is allowed to react with lithium migrating from the positive electrode active material layer 140 so as to form the first lithium-tin alloy layer 120 of FIG. 2; magnesium of the second metal layer 221 is allowed to react with lithium migrating from the positive electrode active material layer 140 so as to form the lithium-magnesium alloy layer 121 of FIG. 2; and tin of the third metal layer 222 is allowed to react with lithium migrating from the positive electrode active material layer 140 so as to form the second lithium-magnesium alloy layer 122 of FIG. 2, whereby the lithium secondary battery 100 can be produced.

### EXAMPLES

The present disclosure will now be described in more detail referring to the below-described Examples; however, the scope of the present disclosure is not limited to the below-described Examples.

### Example 1

### <Production of Negative Electrode Current Collector A1 Having First Metal Layer and Second Metal Layer>

A tin layer was formed at a thickness of 0.1 μm on one side of a nickel foil serving as a negative electrode current collector layer by a sputtering method to form a tin-containing first metal layer on the nickel foil. Subsequently, on the surface of this first metal layer on the nickel foil, a magnesium layer was formed at a thickness of 0.2 μm by a sputtering method to form a magnesium-containing second metal layer on the first metal layer, whereby a negative electrode current collector A1 was obtained. This negative electrode current collector A1 was a laminate having the negative electrode current collector layer, the first metal layer, and the second metal layer in the order mentioned.

### <Production of Electrolyte Layer B1>

An electrolyte mixture slurry was prepared by mixing a sulfide solid electrolyte (92.6 parts by mass) as an electrolyte, a binder (7.4 parts by mass), and an appropriate amount of butyl butyrate as a dispersion medium. The thus obtained electrolyte mixture slurry was coated onto a mold release film with a coating gap of 325 μm, preliminarily dried at room temperature for 3 hours, and then mainly dried at 165° C. for 1 hour. After this main drying, the resulting coated film was punched out into two @14.50 mm pieces, which were then stacked such that their coated surfaces faced each other, and the resultant was subsequently pressed with a pressure of 7.0 tons, after which the mold release film was peeled off to produce a self-supporting electrolyte layer B1.

### <Production of Positive Electrode Active Material Layer C1>

A positive electrode mixture slurry was prepared by mixing nickel cobalt lithium aluminate (NCA, 84.7 parts by mass) as a positive electrode active material, a sulfide solid electrolyte (13.4 parts by mass) as a solid electrolyte, a binder (0.6 parts by mass), a conductive auxiliary agent (1.3 parts by mass), and an appropriate amount of butyl butyrate as a dispersion medium. Subsequently, the thus obtained positive electrode mixture slurry was coated onto an aluminum foil serving as a positive electrode current collector with a coating gap of 225 μm, preliminarily dried at 60° C., and then mainly dried at 165° C. for 1 hour to produce a positive electrode current collector layer C1 formed on the aluminum foil. The thus obtained positive electrode active material layer C1 had a designed capacity of 3.0 mAh/cm² and a basis weight of 18.7 mg/cm².

### <Production of Preliminary Lithium Secondary Battery D1>

The negative electrode current collector A1 and the positive electrode active material layer C1 were punched out into a size of @14.50 mm and a size of @11.28 mm, respectively. Subsequently, the negative electrode current collector A1, the electrolyte layer B1, and the positive electrode active material layer Cl were laminated such that the negative electrode current collector layer, the first metal layer, the second metal layer, the electrolyte layer, the positive electrode active material layer, and the positive electrode current collector layer were arranged in the order mentioned. The thus obtained laminate was housed in a laminated film, which was subsequently vacuum-sealed and then isotropically pressed by cold isotropic pressing at 392 MPa to produce a preliminary lithium secondary battery D1. In this process, aluminum was used as a positive electrode tab, and nickel was used as a negative electrode tab.

### <Production of Lithium Secondary Battery E1>

Using a spring-inserted constant-pressure jig, the preliminary lithium secondary battery D1 was restrained at 1 MPa such that the restraining pressure was constant. Subsequently, this preliminary lithium secondary battery D1 was placed in a 60° C. thermostat chamber, and one cycle of constant current (current density: 0.15 mA/cm², corresponding to 0.05 C)-constant voltage (cut-off current density: 0.03 mA/cm², corresponding to 0.01 C) test was conducted at 60° C. in a cut-off voltage range of 4.2 V to 3.0 V. In this process, by the charging operation of this constant current-constant voltage test of the preliminary lithium secondary battery D1, tin of the first metal layer was allowed to react with lithium migrating from the positive electrode active material layer C1 so as to form a first lithium-tin alloy layer, and magnesium of the second metal layer was allowed to react with lithium migrating from the positive electrode active material layer C1 so as to form a lithium-magnesium alloy layer, whereby a lithium secondary battery E1 was obtained.

### <Electrochemical Measurement of Lithium Secondary Battery E1>

The lithium secondary battery E1 was placed in a 25° C. thermostat chamber, and 20 cycles of constant current (current density: 0.15 mA/cm², corresponding to 0.05 C)-constant voltage (cut-off current density: 0.03 mA/cm², corresponding to 0.01 C) test were conducted at 25° C. in a cut-off voltage range of 4.2 V to 3.0 V. The lithium secondary battery E1 had an initial reversible capacity of 2.82 mAh/cm² at 25° C., and a reversible capacity of 1.46 mAh/cm² after the 20 cycles at 25° C.

### Example 2

### <Production of Electrolyte Layer B2 Having Third Metal Layer>

An electrolyte mixture slurry was prepared by mixing a sulfide solid electrolyte (92.6 parts by mass) as an electrolyte, a binder (7.4 parts by mass), and an appropriate amount of butyl butyrate as a dispersion medium. The thus obtained electrolyte mixture slurry was coated onto a mold release film with a coating gap of 325 μm, preliminarily dried at room temperature for 3 hours, and then mainly dried at 165° C. for 1 hour. After this main drying, the resulting coated film was punched out into two φ14.50-mm pieces, which were then stacked such that their coated surfaces faced each other, and the resultant was subsequently pressed with a pressure of 7.0 tons, after which the mold release film was peeled off to produce a self-supporting electrolyte layer. Thereafter, on one side of the thus obtained self-supporting electrolyte layer, a tin layer was formed at a thickness of 0.1 μm by a sputtering method to form a tin-containing third metal layer on the electrolyte layer, whereby an electrolyte layer B2 was produced.

### <Production of Preliminary Lithium Secondary Battery D2>

A preliminary lithium secondary battery D2 was produced in the same manner as in Example 1, except that the electrolyte layer B2 was used in place of the electrolyte layer B1, and the negative electrode current collector A1, the electrolyte layer B2, and the positive electrode active material layer C1 were laminated such that the negative electrode current collector layer, the first metal layer, the second metal layer, the third metal layer, the electrolyte layer, the positive electrode active material layer, and the positive electrode current collector layer were arranged in the order mentioned.

### <Production of Lithium Secondary Battery E2>

Using a spring-inserted constant-pressure jig, the preliminary lithium secondary battery D2 was restrained at 1 MPa such that the restraining pressure was constant. Subsequently, this preliminary lithium secondary battery D2 was placed in a 60° C. thermostat chamber, and one cycle of constant current (current density: 0.15 mA/cm², corresponding to 0.05 C)-constant voltage (cut-off current density: 0.03 mA/cm², corresponding to 0.01 C) test was conducted at 60° C. in a cut-off voltage range of 4.2 V to 3.0 V. In this process, by the charging operation of this constant current-constant voltage test, tin of the first metal layer was allowed to react with lithium migrating from the positive electrode active material layer Cl so as to form a first lithium-tin alloy layer, magnesium of the second metal layer was allowed to react with lithium migrating from the positive electrode active material layer C1 so as to form a lithium-magnesium alloy layer, and tin of the third metal layer was allowed to react with lithium migrating from the positive electrode active material layer Cl so as to form a second lithium-tin alloy layer, whereby a lithium secondary battery E2 was obtained.

### <SEM-EDX Measurement of Lithium Secondary Battery E2>

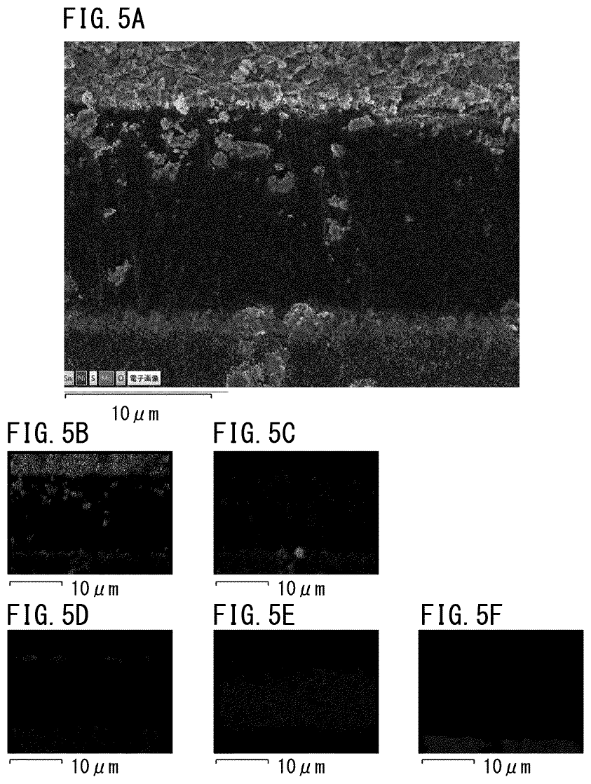

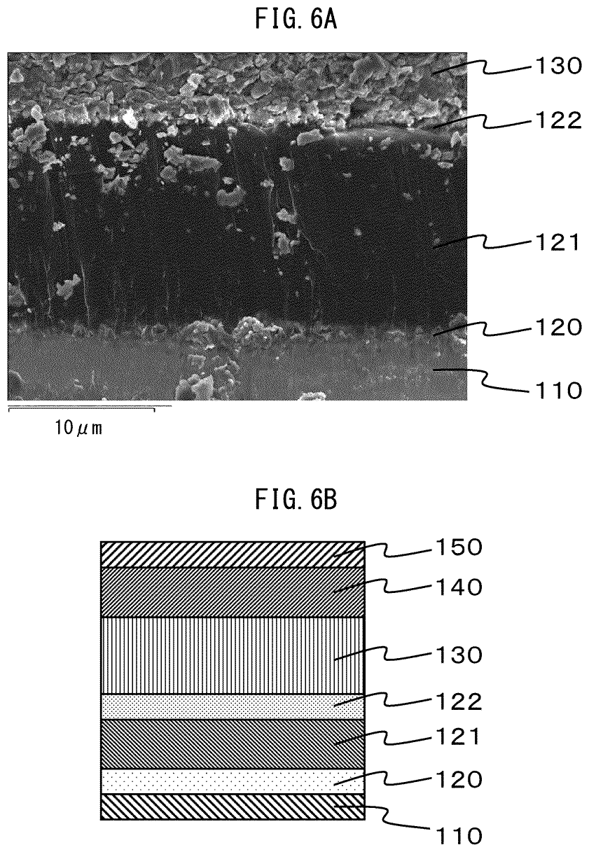

For a cross-section of the lithium secondary battery E2 after initial charging at 60° C., scanning electron microscope (SEM) observation of a secondary electron image obtained at an accelerating voltage of 5 kV, and elemental mapping by energy dispersive X-ray analysis (EDX) were performed. FIG. 5 shows the results of the EDX mapping analysis of the lithium secondary battery E2, and FIG. 6 shows a cross-sectional SEM image of the lithium secondary battery E2 and a schematic drawing of the cross-sectional structure. From the SEM-EDX observation, it was confirmed that, in the lithium secondary battery E2 after the initial charging, the negative electrode current collector layer 110, the first lithium-tin alloy layer 120, the lithium-magnesium alloy layer 121, the second lithium-tin alloy layer 122, and the electrolyte layer 130 were laminated in the order mentioned.

### <Electrochemical Measurement of Lithium Secondary Battery E2>

Electrochemical measurement of the lithium secondary battery E2 was performed in the same manner as in Example 1. The initial reversible capacity of the lithium secondary battery E2 at 25° C. and the reversible capacity of the lithium secondary battery E2 after 20 cycles at 25° C. are shown in Table 1.

### Comparative Example 1

### <Production of Negative Electrode Current Collector A2 Having Second Metal Layer>

On one side of a nickel foil serving as a negative electrode current collector layer, a magnesium layer was formed at a thickness of 0.2 μm by a sputtering method to form a magnesium-containing second metal layer on the nickel foil, whereby a negative electrode current collector A2 was obtained. The thus obtained negative electrode current collector A2 was a laminate having the negative electrode current collector layer and the second metal layer in the order mentioned.

<Production of Preliminary Lithium Secondary Battery d1>

A preliminary lithium secondary battery d1 was produced in the same manner as in Example 1, except that the negative electrode current collector A2 was used in place of the negative electrode current collector A1, and the negative electrode current collector A2, the electrolyte layer B1, and the positive electrode active material layer C1 were laminated such that the negative electrode current collector layer, the second metal layer, the electrolyte layer, the positive electrode active material layer, and the positive electrode current collector layer were arranged in the order mentioned.

<Production and Electrochemical Measurement of Lithium Secondary Battery e1>

A lithium secondary battery e1 was produced in the same manner as in Example 1, except that the preliminary lithium secondary battery d1 was used in place of the preliminary lithium secondary battery D1. Electrochemical measurement of the lithium secondary battery e1 was performed in the same manner as in Example 1. The initial reversible capacity of the lithium secondary battery e1 at 25° C. and the reversible capacity of the lithium secondary battery e1 after 20 cycles at 25° C. are shown in Table 1.

### Comparative Example 2

<Production of Preliminary Lithium Secondary Battery d2>

A preliminary lithium secondary battery d2 was produced in the same manner as in Example 1, except that the negative electrode current collector A2 was used in place of the negative electrode current collector A1, the electrolyte layer B2 was used in place of the electrolyte layer B1, and the negative electrode current collector A2, the electrolyte layer B2, and the positive electrode active material layer C1 were laminated such that the negative electrode current collector layer, the second metal layer, the third metal layer, the electrolyte layer, the positive electrode active material layer, and the positive electrode current collector layer were arranged in the order mentioned.

<Production and Electrochemical Measurement of Lithium Secondary Battery e2>

A lithium secondary battery e2 was produced in the same manner as in Example 1, except that the preliminary lithium secondary battery d2 was used in place of the preliminary lithium secondary battery D1. Electrochemical measurement of the lithium secondary battery e2 was performed in the same manner as in Example 1. The initial reversible capacity of the lithium secondary battery e2 at 25° C. and the reversible capacity of the lithium secondary battery e2 after 20 cycles at 25° C. are shown in Table 1.

Table 1 shows the evaluation results of the electrochemical measurement of Examples 1 and 2 and Comparative Examples 1 and 2.

TABLE 1

| | | | | Comparative | Comparative |
|---|---|---|---|---|---|
| | | Example 1 | Example 2 | Example 1 | Example 2 |
| Preliminary lithium secondary battery | | Preliminary lithium | Preliminary lithium | Preliminary lithium | Preliminary lithium |
| | | secondary battery D1 | secondary battery D2 | secondary battery d1 | secondary battery d2 |
| Negative electrode current collector | | Negative electrode | Negative electrode | Negative electrode | Negative electrode |
| | | current collector A1 | current collector A1 | current collector A2 | current collector A2 |
| | First metal layer | Sn layer (0.1 μm) | Sn layer (0.1 μm) | none | none |
| | Second metal layer | Mg layer (0.2 μm) | Mg layer (0.2 μm) | Mg layer (0.2 μm) | Mg layer (0.2 μm) |
| Electrolyte layer | | Electrolyte layer B1 | Electrolyte layer B2 | Electrolyte layer B1 | Electrolyte layer B2 |
| | Third metal layer | none | Sn (0.1 μm) | none | Sn (0.1 μm) |
| Positive electrode active material layer | | Positive electrode | Positive electrode | Positive electrode | Positive electrode |
| | | active material | active material | active material | active material |
| | | layer C1 | layer C1 | layer C1 | layer C1 |
| Lithium secondary battery | | Lithium secondary | Lithium secondary | Lithium secondary | Lithium secondary |
| | | battery E1 | battery E2 | battery e1 | battery e2 |
| | First lithium-tin alloy layer | Li—Sn layer | Li—Sn layer | none | none |
| | Lithium-magnesium alloy layer | Li—Mg layer | Li—Mg layer | Li—Mg layer | Li—Mg layer |
| | Second lithium-tin alloy layer | none | Li—Sn layer | none | Li—Sn layer |
| Evaluation | Initial reversible capacity (25° C.) | 2.82 | 2.89 | 2.24 | 2.4 |
| results | [mAh/cm²] | | | | |
| | Reversible capacity after 20 cycles (25° C.) | 1.46 | 2.77 | 0.48 | 1.08 |
| | [mAh/cm²] | | | | |

The lithium secondary batteries E1 and E2 in which the first lithium-tin alloy layer was arranged had a higher initial reversible capacity at 25° C. as compared to the lithium secondary batteries e1 and e2 in which the first lithium-tin alloy layer was not arranged. This is presumed to be because, by arranging the first lithium-tin alloy layer between the negative electrode current collector layer and the lithium-magnesium alloy layer, the interfacial delamination between the negative electrode current collector layer and the lithium-magnesium alloy layer was inhibited during discharging, as a result of which the reversible capacity was increased and the cycle characteristics were improved.

The following is considered as a factor that allowed the first lithium-tin alloy layer to inhibit the interfacial delamination between the negative electrode current collector layer and the lithium-magnesium alloy layer. During discharging, from the standpoint of reaction potential, dealloying of lithium contained in the lithium-magnesium alloy layer proceeds preferentially to dealloying of lithium contained in the first lithium-tin alloy layer; therefore, the lithium-magnesium alloy layer contracts greatly. On the other hand, since the lithium-tin alloy layer contracts less than the lithium-magnesium alloy layer, the contraction of the lithium-magnesium alloy layer is relaxed by the lithium-tin alloy layer, and it is presumed that the above-described interfacial delamination was inhibited as a result.

Further, the lithium secondary battery E2 in which the second lithium-tin alloy layer was arranged maintained a high reversible capacity of 2.77 mAh/cm² even after 20 cycles. This is presumed to be because, by arranging the second lithium-tin alloy layer between the lithium-magnesium alloy layer and the electrolyte layer, the interfacial delamination between the lithium-magnesium alloy layer and the electrolyte layer was inhibited during discharging, as a result of which the cycle characteristics were improved. It is noted here that the inhibition of the interfacial delamination by the second lithium-tin alloy layer is presumed to be attributed to the same factor as the inhibition of the interfacial delamination by the first lithium-tin alloy layer.

Preferred embodiments of the lithium secondary battery of the present disclosure have thus been described, and those of ordinary skill in the art would understand that various modifications can be made without departing from the scope of Claims.

### REFERENCE SIGNS LIST

100: lithium secondary battery
110: negative electrode current collector layer
120: first lithium-tin alloy layer
121: lithium-magnesium alloy layer
122: second lithium-tin alloy layer
130: electrolyte layer
140: positive electrode active material layer
150: positive electrode current collector layer
200: preliminary lithium secondary battery
220: first metal layer
221: second metal layer
222: third metal layer

1. A lithium secondary battery comprising a negative electrode current collector layer, a first lithium-tin alloy layer, a lithium-magnesium alloy layer, an electrolyte layer, a positive electrode active material layer; and a positive electrode current collector layer, in the order mentioned.

2. The lithium secondary battery according to claim 1, wherein, in a fully-charged state, the first lithium-tin alloy layer has a thickness of 0.1 to 15 μm.

3. The lithium secondary battery according to claim 1, wherein, in a fully-charged state, the lithium-magnesium alloy layer has a thickness of 0.1 to 40 μm.

4. The lithium secondary battery according to claim 1, comprising the negative electrode current collector layer, the first lithium-tin alloy layer, the lithium-magnesium alloy layer, a second lithium-tin alloy layer, the electrolyte layer, the positive electrode active material layer, and the positive electrode current collector layer, in the order mentioned.

5. The lithium secondary battery according to claim 4, wherein, in a fully-charged state,
the first lithium-tin alloy layer has a thickness of 0.1 to 15 μm, and
the second lithium-tin alloy layer has a thickness of 0.1 to 15 μm.

6. A method of producing the lithium secondary battery according to claim 1, the method comprising the following steps of:
obtaining a preliminary lithium secondary battery by laminating the negative electrode current collector layer, a tin-containing first metal layer, a magnesium-containing second metal layer, the electrolyte layer, the positive electrode active material layer retaining lithium, and the positive electrode current collector layer, in the order mentioned; and
performing a charging operation of the preliminary lithium secondary battery to: (i) allow tin of the first metal layer to react with lithium migrating from the positive electrode active material layer, and thereby form the lithium-tin alloy layer; and (ii) allow magnesium of the second metal layer to react with lithium migrating from the positive electrode active material layer, and thereby form the lithium-magnesium alloy layer.

7. A method of producing the lithium secondary battery according to claim 4, the method including the following steps of:
obtaining the preliminary lithium secondary battery by laminating the negative electrode current collector layer, a tin-containing first metal layer, a magnesium-containing second metal layer, a tin-containing third metal layer, the electrolyte layer, the positive electrode active material layer retaining lithium, and the positive electrode current collector layer, in the order mentioned; and
performing a charging operation of the preliminary lithium secondary battery to: (i) allow tin of the first metal layer to react with lithium migrating from the positive electrode active material layer, and thereby form the first lithium-tin alloy layer; (ii) allow magnesium of the second metal layer to react with lithium migrating from the positive electrode active material layer, and thereby form the lithium-magnesium alloy layer; and (iii) allow tin of the third metal layer to react with lithium migrating from the positive electrode active material layer, and thereby forming the second lithium-tin alloy layer.
